(19) United States
(12) Patent Application Publication
(10) Pub. No.: US 2010/0296420 A1
(43) Pub. Date: Nov. 25, 2010

(54) METHOD AND NODES FOR REVOKING A BINDING IN A MOBILE IP NETWORK

(75) Inventors: Desire Oulai, Longueuil (CA); Suresh Krishnan, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/471,050

(22) Filed: May 22, 2009

(51) Int. Cl. H04B 7/00

(52) U.S. Cl. 370/310

(57) ABSTRACT

A method for revoking a binding from a mobile node, having a least one binding, comprises providing a target binding with the binding revocation message, so that after the revocation, the mobile node can be reached through the target binding.

### TECHNICAL FIELD

The present invention generally relates to mobile IP networks. More specifically, the present invention is concerned with a method and nodes for revoking a binding in a mobile IP network.

### BACKGROUND

Over the past few decades, telecommunications and Internet have experienced an incredible growth and expansion. Technologies have changed from centralized computing to personalized computing and now to mobile computing with a convergence of networks, devices and services.

Mobile computing is made possible through the use of Mobile IP or more specifically Mobile IPv6 (MIPv6 ), using the version 6 of Internet Protocol (IP). MIPv6 is an Internet Engineering Task Force (IETF) standard communication protocol. It has been designed to allow mobile users to move from one network to another one without experiencing discontinuity of services. Indeed, MIPv6 protocol provides continuous IP services to a mobile node (MN), by maintaining connectivity of the MN with different networks. The mobile node could be a mobile phone, a laptop or PDA, etc.

The mobility services are deployed through a Home Agent (HA) which provides a Home Address (HoA) to a MN registered with that HA. When the MN moves away and attaches itself to a different access router, it acquires a new address, called the Care-Of Address (CoA). The MN then sends a Binding Update (BU) to the HA in order to bind the CoA to the HoA, so that traffic directed to the HoA is forwarded to the CoA. The HA replies back to the MN with a Binding Acknowledgement (BA) and forwards each packet with the HoA as destination address to the CoA using a bidirectional tunnel, for example. By so doing, the mobile node (MN) is able to move between different networks without ending ongoing sessions as the HoA of the MN remains unchanged.

Since any IPv6 node has the ability to obtain several IPv6 addresses, a MN can have more than one HoAs and several CoAs bound to each of the HoAs, i.e. it is possible for the MN to register several CoAs with the same HoA. In that case, each CoA/HA binding is identified by a Binding Identifier (BID). However for some reasons, such as for administrative reasons, a HA can decide to revoke a specific binding between the HoA and the CoA. To do so, the HA sends a Binding Revocation Indication (BRI) message to the mobile node with an identification of the binding to be removed/revoked. The MN responds back with a Binding Revocation Acknowledgement (BRA) message to confirm the removal/revocation of the identified binding.

However, in current mobile IP networks, a problem arises after the revocation of the binding. Indeed, after such revocation, the traffic flows that were using the revoked binding, are generally dropped or routed using a default binding, which is not optimal. Also, in certain cases, the MN can actively search for a new and optimal binding by querying different entities in the mobile IP network. But such queries usually lead to delays and packet loss of the traffic flows, which may be harmful in applications such as real-time applications.

Thus, a general problem that needs to be overcome is to provide a more interesting binding revocation method in mobile IP networks.

### SUMMARY

More specifically, in accordance with a first aspect of the present invention, there is provided a method for revoking a binding from a mobile node in a mobile IP network, the mobile node having at least one binding indicated by a corresponding binding identifier (BID). The method comprises the steps of: providing a first binding identifier corresponding to a target binding to the mobile node; and sending a revocation message specifying a second binding identifier (BID) corresponding to a binding from the at least one binding to be revoked at the mobile node. Upon revocation of the binding from the at least one binding, the target binding maintains reachability of the mobile node.

According to a second aspect of the invention, there is provided a method for revoking a binding from a mobile node in a mobile IP network, the mobile node having at least one binding indicated by a corresponding binding identifier (BID). The method comprises the steps of: receiving a first binding identifier corresponding to a target binding; and receiving a revocation message specifying a second binding identifier (BID) corresponding to a binding from the at least one binding to be revoked at the mobile node. Upon revocation of the binding from the at least one binding of the mobile node, the target binding maintains reachability of the mobile node.

According to a third aspect of the invention, there is provided a mobile node, in which a binding is to be revoked, the mobile node having at least one binding indicated by a corresponding binding identifier (BID). The mobile node comprises: a receiving module which receives a first binding identifier corresponding to a target binding and a revocation message specifying a second binding identifier (BID) corresponding to the binding to be revoked at the mobile node. Upon revocation of the binding, the target binding maintains reachability of the mobile node.

According to a fourth aspect of the invention, there is provided a network node for revoking a binding from a mobile node, in a mobile IP network, the mobile node having at least one binding indicated by a corresponding binding identifier (BID). The network node comprises a flow module which determines a first binding identifier corresponding to a target binding, the first binding identifier being sent to the mobile node; and a transmitting module which sends a revocation message specifying a second binding identifier (BID) corresponding to a binding from the at least one binding to be revoked at the mobile node. Upon revocation of the binding, the target binding maintains reachability of the mobile node.

The foregoing and other aspects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 illustrates a simplified view of a mobile IP network;

FIG. 2 is a schematic view of a Binding Revocation Indication (BRI ) message of the prior art;

FIG. 3 is a schematic view of a Binding Revocation Indication (BRI) message according to a non-restrictive illustrative embodiment of the present invention;

FIG. 4A is a flow chart illustrating a method for revoking a binding of a mobile node, according to a non-restrictive illustrative embodiment of the present invention;

FIGS. 4B and 4C are flow charts illustrating two different methods of implementing the method of FIG. 4A;

FIG. 5 is a flow chart illustrating another method for revoking a binding of a mobile node, according to a non-restrictive illustrative embodiment of the present invention;

FIG. 6 is a schematic view of a mobile node, for revoking a binding, according to a non-restrictive illustrative embodiment of the present invention; and

FIG. 7 is a schematic view of a network node, for revoking a binding, according a non-restrictive illustrative embodiment of the present invention.

### DETAILED DESCRIPTION

Generally stated, a non-restrictive illustrative embodiment of the present invention allows for revoking a binding of a mobile node, between a HoA and a CoA, in such a way that a new binding is also indicated for maintaining reachability of the mobile node after the revocation. For example, the traffic flows whose binding has just been revoked can be rerouted using the new binding, the new binding being referred to as the target binding.

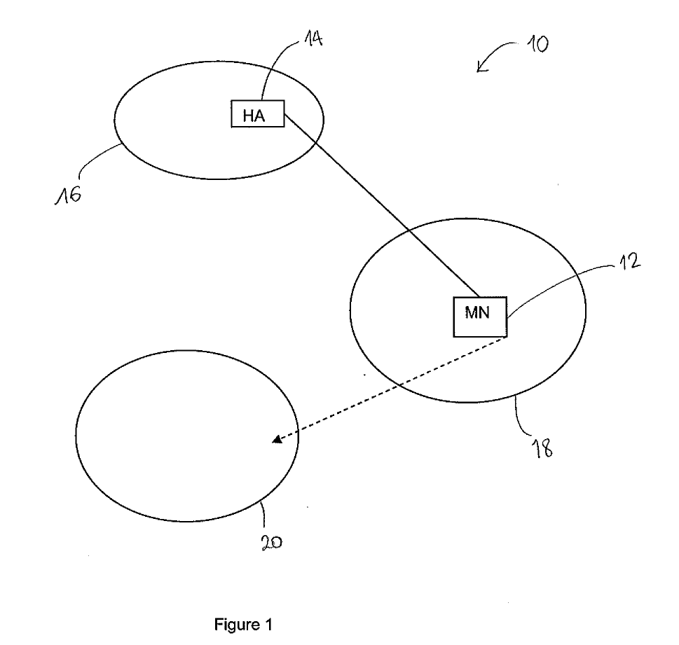

Now, turning to FIG. 1, a simplified mobile IP network, such as a mobile IPv6 network is shown. The mobile IP network 10 has been simplified for clarity purposes, i.e. only parts of the mobile IP network 10 which are relevant to an embodiment of the present invention are shown, without necessarily showing all the elements that are present in such a network.

The mobile IP network 10 comprises a mobile node (MN) 12, a home agent (HA) 14, a home network 16, and different networks, such as foreign networks 18 and 20 (only two are shown, but there can be more). As mentioned earlier, the mobile IP network 10 can comprise a plurality of additional elements well-known to the person skilled in the art.

The MN 12 is registered with the HA 14, in its home network 16. The HA 14 assigns a home address (HoA) to the MN 12 so as to identify it. When the MN 12 roams and attaches itself to a foreign network, such as 18, it acquires a care-of-address (CoA). The MN 12 sends a binding update to the HA 14 so as to bind the CoA to the HoA. By so doing, the MN 12 remains reachable. If the mobile node 12 roams to another foreign network, such as 20, it acquires another CoA and can bind that new address to the HoA. Each such CoA/HoA binding is identified by a Binding Identifier (BID). The BID is specified in an option of the Binding Update message. Also, the BID is usually stored in the binding cache entry of the HA 14 and in a binding update list entry of the MN 12.

The IETF (Internet Engineering Task Force) has defined a protocol allowing a network node, such as the HA 14, to revoke a binding from a mobile node, such as 12, registered thereto, for administrative reasons, for example, the MN 12 has no more credits for its prepaid services or the MN 12 has been moved to a blacklist. As specified by this protocol, to initiate a revocation, the HA 14 sends a Binding Revocation Indication (BRI) message to the MN 12. The BRI message comprises a field for specifying the BID corresponding to the binding to be revoked, in the case where the MN 12 has a plurality of bindings.

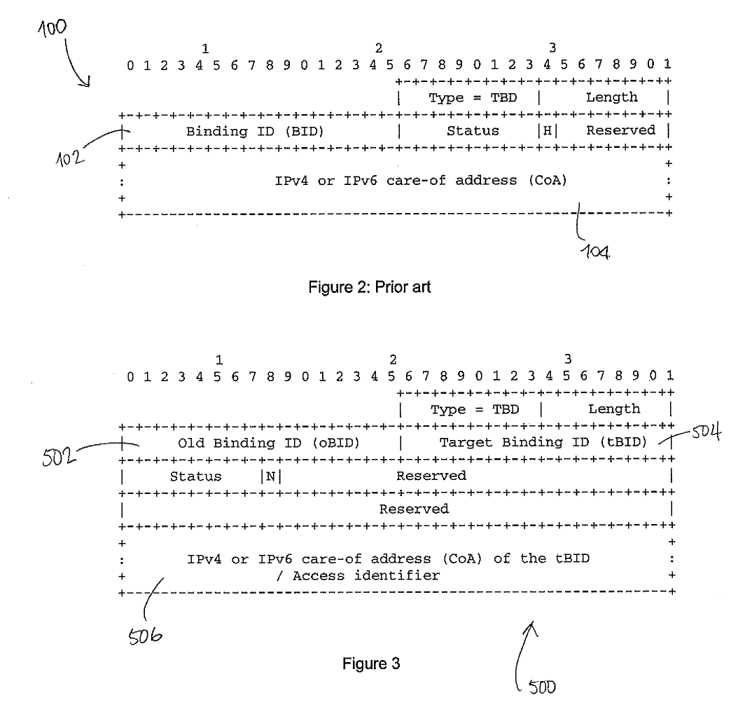

FIG. 2 shows an example of a BRI message 100. It comprises the field 102 for specifying the BID of the binding to be revoked. Also, it comprises the field 104 for specifying the address of the binding to be revoked, which corresponds to the CoA. The address in the field 104 can be used to check the matching with the specified BID in the field 102. The other fields are believed to be well-known in the art or to be determined, and do not need to be described further.

In response to the received BRI message, the MN 12 sends back a Binding Revocation Acknowledgement (BRA) message including the same BID to confirm the revocation of the corresponding binding.

After such binding revocation, the traffic flows that were using the revoked binding are often dropped, rerouted to a default binding or a binding queried by the MN 12.

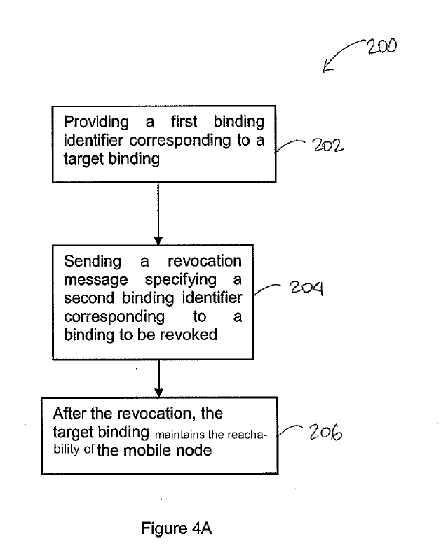

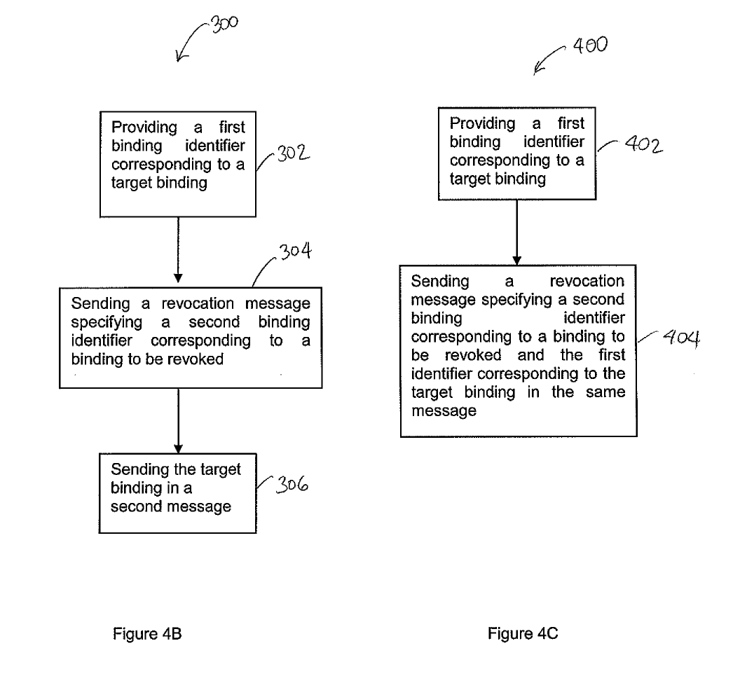

Now, turning to FIG. 4A, a method 200 for revoking a binding from the MN 12 in the mobile IP network 10, according to a non-restrictive illustrative embodiment of the present invention, will be described.

First, the MN 12 is assumed to have at least one binding HoA/CoA, identified by corresponding BIDs.

For some administrative reasons, the HA 14 decides to revoke a binding from the at least one binding of the MN 12. To do so, in step 202 of method 200, the HA 14 provides a first binding identifier (BID) corresponding to a target binding to the MN 12.

For example, the HA 14 can determine towards which new or existing binding (i.e. target binding) or access network to redirect the traffic flows which are using the binding to be revoked or how to simply maintain reachability of the MN 12 after the revocation. This determination of the target binding can be based on some specific network politics or cost considerations, or other factors. For example, there may be a policy that states to move all video traffic to a LTE (Long Term Evolution) network, or to move all data traffic to a WLAN, when the data traffic exceeds a threshold, etc.

In step 204, the HA 14 sends a revocation message to the MN 12, specifying a second binding identifier (BID) corresponding to a binding from the at least one binding to be revoked at the mobile node 12.

After the revocation of the binding from the at least one binding of the MN 12, the MN 12 can be reached easily by using the target binding, without introducing any delays or packet loss, in step 206. Also, for the traffic flows that were using the revoked binding, they can be redirected/rerouted using the target binding.

More specifically, method 200 can be implemented in two different ways, using method 300 or method 400 as will be described hereinbelow.

Turning to FIG. 4B, method 300 for revoking a binding of the MN 12 will be now described.

In step 302, the HA 14 provides a first identifier corresponding to the target binding, which is determined based on different network policies and cost considerations, for example.

In step 304, the HA 14 sends a revocation message to the MN 12, such as the BRI message of FIG. 2, specifying a binding to be revoked by indicating its corresponding BID.

In step 306, subsequently after the sending of the revocation message, the HA 14 sends a second message to the MN 12, including the target binding identified by its identifier (e.g., BID).

It should be noted that the second message is sent on the own initiative of the HA 14 after sending the revocation message, without any request or involvement from the MN 12.

Also, it should be understood that the second message, which includes the target binding identifier can be also sent prior to sending the revocation message, with an indication that the target binding is to be used after a binding revocation. In that case, the MN 12 can store the second message first and after it receives the revocation message, it can use the target binding to reroute its traffic flows.

The second method 400 is given in FIG. 4C and is the preferred embodiment.

Method 400 starts with step 402, in which the HA 14 provides a first identifier corresponding to a target binding, which is determined based on different network policies and cost considerations, for example. The HA 14 can also query external servers to determine the most appropriate access router to use.

In step 404, the HA 14 sends a revocation message. However, in this case, the message revocation includes a second BID corresponding to the binding to be revoked and the first binding identifier identifying the target binding.

An example of this new revocation message is illustrated in FIG. 3. The new revocation message 500 is created by the HA 14. For example, the field 502 of the revocation message 500 comprises the second identifier corresponding to the binding to be revoked, also referred to as the old BID (oBID). In the field 504, the HA 14 adds the first BID, also referred to as the target BID (tBID), corresponding to the target binding. In the field 506, the address of the target binding is provided. However, the field 506 is optional, for revocation purposes, because the tBID is sufficient for identifying the binding to be revoked. But, the address of the target binding, provided in field 506, can be used to check the matching with the tBID. Also, an access identifier can be indicated in field 506, if a new binding needs to be created, i.e. the target binding indicates a new binding.

It should be noted that even if a MN 12 does not support the exemplary embodiment of the present invention, due to the presence of the old BID, the MN 12 can still correctly revoke the old binding according to the current binding revocation procedure.

Furthermore, in the case that the HA 14 determines that the target binding should be a new binding (not an existing binding), the field 508 is used to indicate to the MN 12 to create this new binding. To do so, the bit N in field 508 is set to one (1), meaning that a new binding is required and the tBID is set to all zeros (0). Also, in this case, the field 506 comprises an Access Identifier (AI), which allows for identifying a network, an access router or a technology. Of course, a person skilled in the art would understand that other number values can be used to specify a new binding.

After the MN 12 receives the new revocation message 500, it will route all its traffic flows using the target binding, i.e. the traffic flows will be directed to the addresses specified in the target binding.

However, if the MN 12 does not support the new option (tBID) in the revocation message, it can skip that option and then continue with the current binding revocation procedure, as known in the prior art. If the MN 12 supports the new tBID option, but the N bit in field 508 is set to one and the tBID is set to zero, meaning that a new binding is needed, then the MN 12 creates the new binding with the HA 14 using the access identifier (AI) provided in field 506 of the revocation message 500. Once the new binding is created, the traffic flows will be sent towards that new binding. And if the target binding given by the tBID is an existing binding, then the MN 12 can just route the traffic flows using the existing binding.

Next, the MN 12 creates a BRA message. This message includes the same options as in the revocation message 500, i.e. the oBID and the tBID. The BRA message is sent to the HA 14 for revocation confirmation. Also, the BRA message can be used to confirm with the HA 14 the use of the tBID after the revocation of the oBID.

Upon receipt of the BRA message, the HA 14 tears down or revokes the binding specified by the oBID and then routes the traffic flows towards the target binding identified by the tBID, i.e. the HA 14 uses the target binding to reach the mobile node 12.

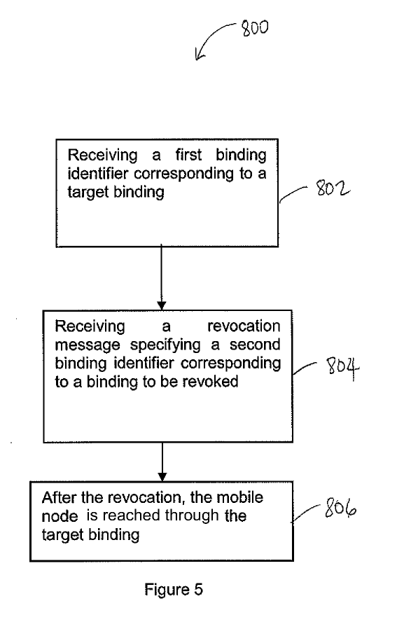

In FIG. 5, another method for revoking a binding from the mobile node 12, according to a non-restrictive illustrative embodiment of the present invention, is illustrated. Method 800 is viewed from the point of view of the MN 12.

Method 800 starts with step 802, when the MN 12 receives a first binding identifier corresponding to a target binding, determined by the HA 14.

In step 804, the MN 12 receives a revocation message specifying a second binding identifier corresponding to the binding to be revoked.

In step 806, after revocation of the binding, the target binding is used for reaching the MN 12.

It should be noted that, in method 800, receiving the revocation message can also comprise receiving the first binding identifier corresponding to the target binding. In this case, the revocation message includes both the first identifier corresponding to the target binding and the second binding identifier corresponding to the binding to be revoked, as shown in the revocation message 500 of FIG. 3. Thus, the MN 12 receives such a revocation message.

However, the MN 12 can also receive two different messages, one containing the first identifier and another message containing the second identifier. The order of receiving the two messages does not matter, as long as the MN 12 does not initiate any requests and that two different messages are received, i.e. the message with the first identifier can be received prior to receiving the revocation message or subsequently after receiving the revocation message, without the MN 12 requesting it. In the case where the revocation message with the BID to be revoked is received by the MN 12 before the message containing the tBID, the MN 12 does not take actions for revocation until it receives the message containing the tBID.

After receiving the binding revocation and the target binding, the MN 12 responds back to the HA 14 by sending a revocation acknowledgement message (BRA).

The BRA message contains the first binding identifier and the second binding identifier so as to confirm the binding revocation and the use of the first binding (tBID) after the revocation of the binding.

After the revocation, the MN 12 uses the target binding to route its traffic flows, meaning that the traffic is directed to the addresses specified in the target binding.

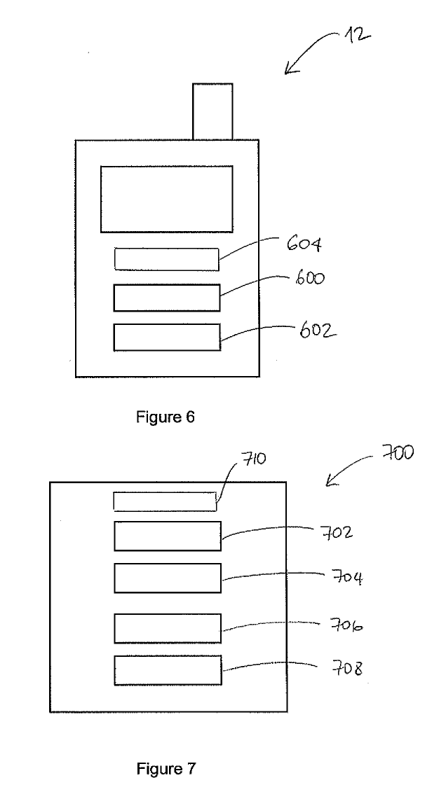

Turning to FIG. 6, a mobile node, according to a non-restrictive illustrative embodiment of the present invention will be now described.

The mobile node, such as the MN 12, comprises, for example, a receiving module 600, a transmitting module 602 and a binding update list entry 604. Of course, the MN 12 further includes many additional elements (not shown), such as a processor or memory, for performing its usual tasks and procedures, which are well known in the art and thus will not be described further, in addition to the tasks and procedures of the present invention.

The receiving module 600 is used to receive the new revocation message 500 of FIG. 5, sent by the HA 14, for example. The receiving module 600 is also used for receiving the BRI message 100 of Figure 2 and the message containing the identifier identifying the target binding.

The transmitting module 602 is used to send the BRA message to the HA 14 to confirm the revocation and the use of the target binding after the revocation. The BRA message is sent after the MN 12 receives the revocation message 500 or the BRI message 100 and the message containing the identifier identifying the target binding.

The binding update list entry 604 can be a database or a memory and is used to store the binding identifiers (BID) of each binding. When a binding is revoked, the corresponding BID is removed from the binding update list entry 604. When a new binding is created, the corresponding BID is stored in the binding update list entry 604.

A network node, according to a non-restrictive illustrative embodiment of the present invention, is illustrated in FIG. 7. The network node 700 can be for example the HA 14.

The network node 700 comprises a flow module 702, a transmitting module 704, a receiving module 706, a routing module 708 and a binding cache entry 710. Of course, the network node 700 also comprises a plurality of additional components (not shown), such as a processor or memory, for performing its usual tasks and procedures, which are well-known in the art and thus will not be described further, in addition to the tasks and procedures of the present invention.

The flow module 702 allows for determining the target binding when the network node 700 decides to revoke a binding from the MN 12. The flow module 702 can determine the target binding based on network policies or cost considerations or query external servers for an appropriate access router, for example.

The transmitting module 704 allows for transmitting the revocation message to the MN 12. The revocation message can be the conventional BRI message 100 of FIG. 2 or the new revocation message 500 containing also the identifier of the target binding. In the case where the revocation message is the conventional BRI message 100, the transmitting module 704 also sends a second message containing the target binding prior to or subsequently after the sending of the BRI message 100.

The receiving module 706 allows for receiving the BRA message from the MN 12 for confirming the binding revocation message and the use of the target binding after the revocation.

After the reception of the BRA message, the routing module 708 tears down the binding to be revoked and routes the traffic flows to the target binding.

The binding cache entry 710 can be a database or a memory and is used to store the binding identifiers (BID) of each binding. When a binding is revoked, the corresponding BID is removed from the binding cache entry 710. When a new binding is created, the corresponding BID is stored in the binding cache entry 710.

The target binding allows the MN 12 to find without substantial delays the appropriate binding to use for routing the traffic flows after a binding revocation, thus there is no delays or packet loss introduced in the mobile IP network 10 when binding revocation is performed. Accordingly, the traffic flows can be provided with the necessary QoS.

Although the present invention has been described in the foregoing specification by means of a non-restrictive illustrative embodiment, this illustrative embodiment can be modified at will within the scope and nature of the subject invention.

1. A method for revoking a binding from a mobile node in a mobile IP network, the mobile node having at least one binding indicated by a corresponding binding identifier (BID), the method comprising the steps of:
providing a first binding identifier corresponding to a target binding to the mobile node; and
sending a revocation message specifying a second binding identifier (BID) corresponding to a binding from the at least one binding to be revoked at the mobile node;
wherein, upon revocation of the binding from the at least one binding, the target binding maintains reachability of the mobile node.

2. A method as defined in claim 1, wherein the step of sending the revocation message comprises the step of providing the first binding identifier to the mobile node.

3. A method as defined in claim 2, wherein the revocation message comprises the first binding identifier corresponding to the target binding and the second identifier corresponding to the binding to be revoked.

4. A method as defined in claim 3, wherein the revocation message further comprises an address corresponding to the target binding.

5. A method as defined in claim 1, wherein providing the first binding identifier comprises determining the target binding based on specific network policies and cost considerations.

6. A method as defined in claim 1, wherein the step of providing the first binding identifier comprises the step of sending a further message to the mobile node, subsequently after sending the revocation message, the further message including the first binding identifier.

7. A method as defined in claim 1, wherein the step of providing the first binding identifier comprises the step of sending a further message to the mobile node, prior to sending the revocation message, the further message including the first binding identifier.

8. A method as defined in claim 1, further comprising receiving a binding revocation acknowledgement message (BRA).

9. A method as defined in claim 8, wherein the BRA message comprises the first binding identifier and the second binding identifier.

10. A method as defined in claim 9, upon reception of the BRA message, further comprising tearing down the binding corresponding to the second identifier.

11. A method as defined in claim 10, further comprising routing traffic flows that were using the revoked binding to the target binding.

12. A method as defined in claim 1, wherein the target binding comprises a new binding.

13. A method for revoking a binding from a mobile node in a mobile IP network, the mobile node having at least one binding indicated by a corresponding binding identifier (BID), the method comprising the steps of:
receiving a first binding identifier corresponding to a target binding; and
receiving a revocation message specifying a second binding identifier (BID) corresponding to a binding from the at least one binding to be revoked at the mobile node;
wherein, upon revocation of the binding from the at least one binding of the mobile node, the target binding maintains reachability of the mobile node.

14. A method as defined in claim 13, wherein the step of receiving the revocation message comprises the step of receiving the first binding identifier corresponding to the target binding.

15. A method as defined in claim 14, wherein the revocation message includes the first binding identifier corresponding to the target binding and the second binding identifier corresponding to the binding to be revoked.

16. A method as defined in claim 15, wherein the revocation message further includes an address corresponding to the target binding.

17. A method as defined in claim 13, wherein the step of receiving the first binding identifier occurs prior to the step of receiving the revocation message specifying the second identifier.

18. A method as defined in claim 13, wherein the step of receiving the first binding identifier occurs subsequently after the step of receiving the revocation message specifying the second identifier.

19. A method as defined in claim 13, further comprising sending a binding revocation acknowledgement message (BRA).

20. A method as defined in claim 19, wherein the BRA message comprises the first binding identifier and the second binding identifier.

21. A method as defined in claim 13, wherein the target binding comprises a new binding.

22. A mobile node, in which a binding is to be revoked, the mobile node having at least one binding indicated by a corresponding binding identifier (BID), comprising:
a receiving module which receives a first binding identifier corresponding to a target binding and a revocation message specifying a second binding identifier (BID) corresponding to the binding to be revoked at the mobile node;
wherein, upon revocation of the binding, the target binding maintains reachability of the mobile node.

23. A mobile node as defined in claim 22, wherein the receiving module receives the first binding identifier in the same message as the revocation message.

24. A mobile node as defined in claim 23, wherein the revocation message further comprises an address corresponding to the target binding.

25. A mobile node as defined in claim 22, wherein the receiving module receives the first binding identifier in a further message, wherein the further message is received prior to receiving the revocation message.

26. A mobile node as defined in claim 22, wherein the receiving module receives the first binding identifier in a further message, wherein the further message is received subsequently after receiving the revocation message.

27. A mobile node as defined in claim 22, further comprising a transmitting module for sending out a binding revocation acknowledgement message (BRA).

28. A mobile node as defined in claim 27, wherein the BRA message comprises the first binding identifier and the second binding identifier.

29. A network node for revoking a binding from a mobile node, in a mobile IP network, the mobile node having at least one binding indicated by a corresponding binding identifier (BID), the network node comprising:
a flow module which determines a first binding identifier corresponding to a target binding, the first binding identifier being sent to the mobile node; and
a transmitting module which sends a revocation message specifying a second binding identifier (BID) corresponding to a binding from the at least one binding to be revoked at the mobile node;
wherein, upon revocation of the binding, the target binding maintains reachability of the mobile node.

30. A network node as defined in claim 29, wherein the transmitting module sends the first binding identifier corresponding to the target binding to the mobile node in the same message as the revocation message.

31. A network node as defined in claim 30, wherein the revocation message further comprises an address corresponding to the target binding.

32. A network node as defined in claim 29, wherein the flow module determines the target binding based on specific network policies and cost considerations.

33. A network node as defined in claim 29, wherein the transmitting module sends the first binding identifier in a further message to the mobile node, wherein the further message is sent prior to sending the revocation message.

34. A network node as defined in claim 29, wherein the transmitting module sends the first binding identifier in a further message to the mobile node, wherein the further message is sent subsequently after sending the revocation message.

35. A network node as defined in claim 29, further comprising a receiving module for receiving a binding revocation acknowledgement message (BRA).

36. A network node as defined in claim 35, wherein the BRA message comprises the first binding identifier and the second binding identifier.

37. A network node as defined in claim 29, further comprising a routing module for tearing down the binding corresponding to the second identifier and for reaching the mobile node using the target binding.
